(19) United States
(12) Patent Application Publication
(10) Pub. No.: US 2003/0137599 A1
(43) Pub. Date: Jul. 24, 2003

(54) DIY-assembled easy digital camera

(76) Inventor: Jone Su, Chu-Pei City (TW)

Correspondence Address: SUPREME PATENT SERVICES, POST OFFICE BOX 2339, SARATOGA, CA, 95070, US

(21) Appl. No.: 10/053,996

(22) Filed: Jan. 18, 2002

(51) Int. Cl. H04N 5/225; H04N 5/228

(52) U.S. Cl. 348/376; 348/374; 348/375

(57) ABSTRACT

A DIY-assembled easy digital camera mainly comprises a flush base plate of package foldable for building box and a digital camera module. A fixing base is glued on the base plate having a battery seat and a circuit board seat for receiving a battery pack and the digital camera module respectively. A fixing hole for setting a viewfinder is perforated in the base plate of package at a proper position where the fixing base is bound with the base plate of package. An opening is formed in the base plate at a location corresponding to a lens and the viewfinder such that the lens and the viewfinder can be exposed to the air through the opening for picture-taking operation.

### FIELD OF THE INVENTION

This invention relates generally to digital cameras, particularly to a DIY-assembled easy digital camera, which is packed with simple package material instead of a conventional injection molded casing.

### BACKGROUND OF THE INVENTION

As pictures taken can be transmitted in realtime to people at a far end via computers and the Internet unlimitedly and effectively, the digital camera has become one of the hot external peripherals of computer in recent days.

Thanks to the amazing progress of minimization technology for chips, the pocket digital camera is available now in market for people to take pictures any time at any place.

Most people might already have or shall have enjoyed not only the fun but also the pleasure of accomplishment of do-it-yourself in assembling knockdown type furniture, etc. People may have the same feeling when assembling a digital camera on the one hand, they'll be rewarded too with a lower expenditure on the other hand.

A generic easy digital camera is usually composed of a lens, battery, viewfinder, shutter, and electronic components (microprocessor, memory, CCD, etc.) contained in an injection molded plastic casing. When taking a picture, a charge-coupled device (CCD) will convert optical signals into electric signals, which are then stored in a memory device. To an average user, a conventional economic flush casing of digital camera might look more intimate than the injected and provide extra joy in assembling accomplishment.

### SUMMARY OF THE INVENTION

The primary object of this invention is to provide a DIY-assembled easy digital camera comprising a flush base plate of package foldable for building box and a digital camera module, in which a fixing base is glued on the base plate having a battery seat and a circuit board seat for receiving a battery pack and the digital camera module respectively; a fixing hole for setting a viewfinder is perforated in a proper position where the fixing base is bound with the base plate of package; and an opening is formed in the base plate at a location corresponding to a lens and the viewfinder such that the lens and the viewfinder can be exposed through the opening for picture-taking.

Another object of this invention is to provide an easy digital camera, in which the injection molded plastic casing is substituted by a conventional package box. The digital camera mainly comprises a package box and a digital camera module, in which a fixing base and a fixing hole are provided to the package box for setting the digital camera module and a battery pack as well as a viewfinder respectively. Besides, an opening is formed in the package box to permit exposure of the viewfinder and the lens for picture-taking operation.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic view of a digital camera module;

FIG. 2 is an extended view showing a base plate of package and a digital camera module of the DIY-assembled easy digital camera of this invention;

FIG. 3 is an assembled view showing the base plate of package and the digital camera module of the DIY-assembled easy digital camera of this invention; and

FIG. 4 is a schematic three-dimensional view of the DIY-assembled easy digital camera of this invention packaged in a box.

### DETAILED DESCRIPTION OF THE INVENTION

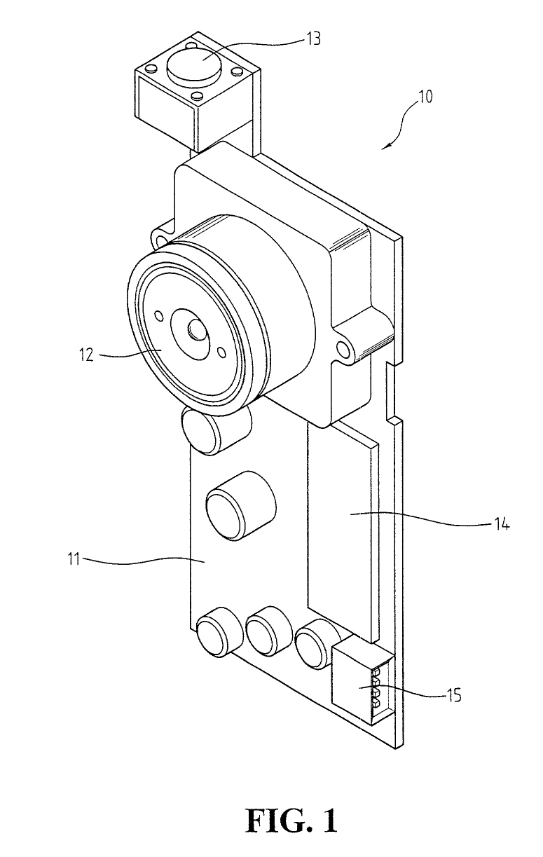

Referring to FIG. 1, a digital camera module 10 contains a circuit board 11, whereon a lens 12, a shutter button 13, and some electronic components 14, including a microprocessor, memory device, charge-coupled device (CCD), output interface, etc., are loaded. After power is supplied, the shutter button 13 is controlled and the optical signals of an external entity are focused on the CCD through the lens 12, then converted into electric signals, processed by the microprocessor, stored in the memory device, and dumped via the output interface to display or print.

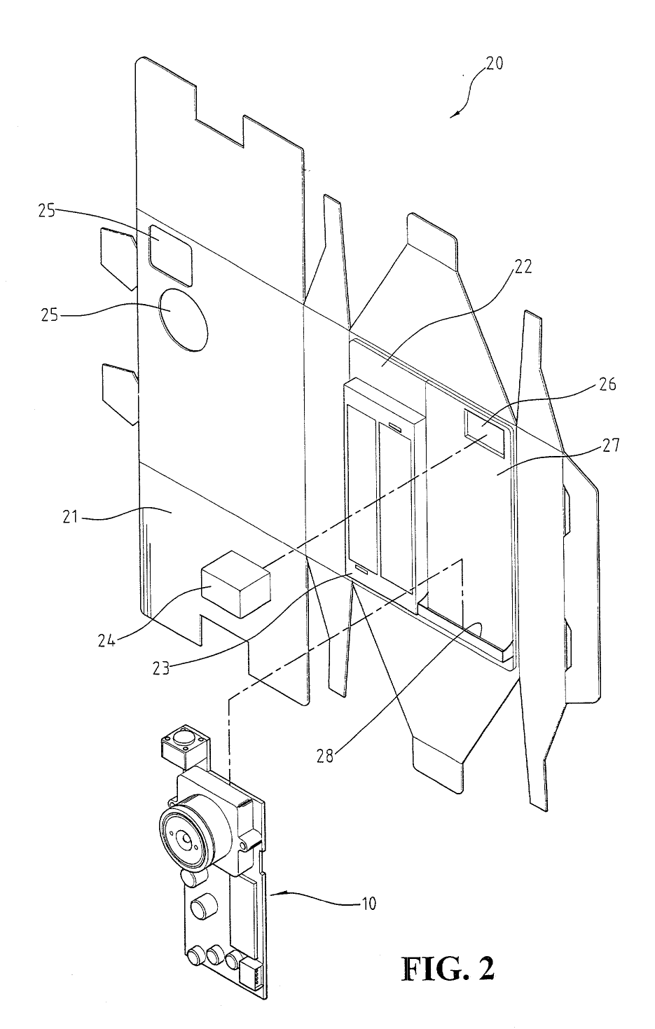

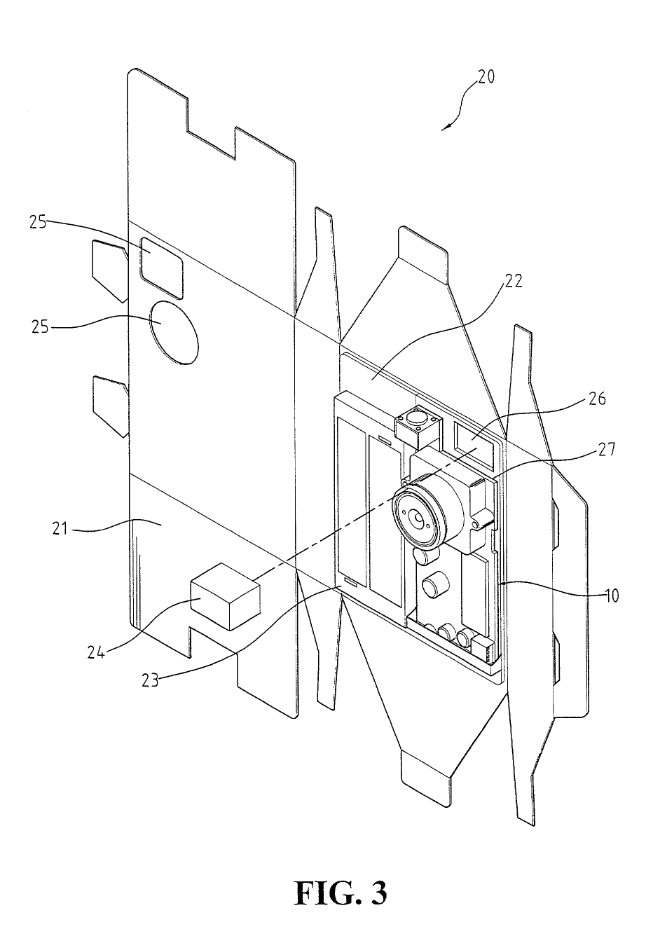

In this invention, a generic package material is adopted instead of the conventional injection plastic material for packing the digital camera module in a foldable box. As indicated in FIGS. 2 and 3, a DIY-assembled easy digital camera 20 of this invention comprises a flush base plate 21 of package foldable for building box and the digital camera module 10. For the sake of fixedly laying the digital camera module 10, a fixing base 22 is glued on the base plate 21 having a battery seat 23 and a circuit board seat 27 for receiving a battery pack and the digital camera module 10 respectively.

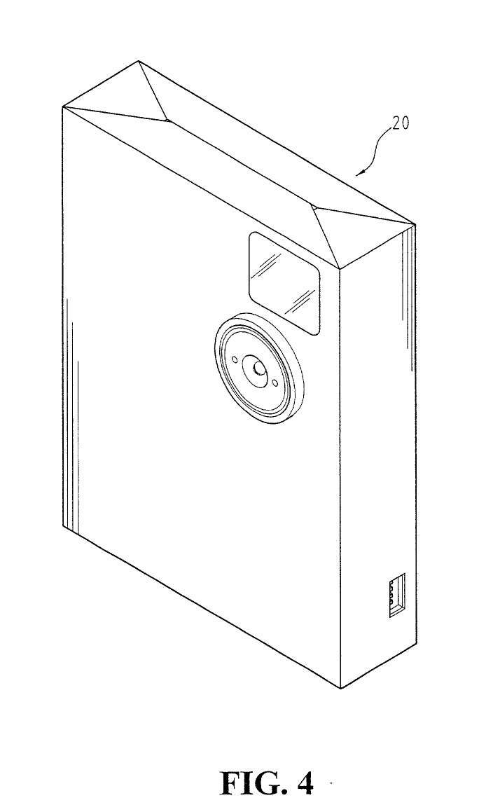

In a preferred embodiment of the circuit board seat 27, a buckling groove 28 is provided to choke the circuit board 11 for laying the digital camera module 10 on the circuit board seat 27. A fixing hole 26 for setting a viewfinder 24 is perforated in a proper position where the fixing base 22 is bound with the base plate of package. An opening 25 is formed in the base plate 21 at a location corresponding to the lens 12 and the viewfinder 24 such that the lens 12 and the viewfinder 24 are exposed through the opening 25 for picture-taking when the base plate of package 21 is folded to build a box (shown in FIG. 4). The shutter button 13 is hidden in a box formed by folding the base plate of package however, it still can be depressed to control the shutter by taking advantage of the soft top face of the base plate of package.

Referring again to FIG. 4, in a preferred embodiment of the base plate of package for building a cubic box, the base plate is a polyvinyl chloride (PVC) lamina and the output interface 15 is a USB port.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A DIY-assembled easy digital camera, comprising:
a digital camera module having a lens, shutter button, electric components, and output interface, all disposed on a circuit board; and
a flush base plate of package foldable for building box, having a fixing base glued thereon, the fixing base further comprising a battery seat for fitting batteries and a circuit board seat for laying the camera module, in which a fixing hole for setting a viewfinder is perforated in a position where the fixing base is glued to the base plate of package; and an opening is disposed in the base plate of package at a location corresponding to the lens and the viewfinder such that the lens and the viewfinder can be exposed to the air through the opening for picture-taking operation.

2. The easy digital camera according to claim 1, in which a buckling groove is formed in the circuit board seat for retaining the circuit board to lay the digital camera module.

3. The easy digital camera according to claim 1, in which the base plate of package is a polyvinyl chloride (PVC) lamina.

4. A DIY-assembled easy digital camera, comprising:
a digital camera module having a lens, shutter button, electric components, and output interface, all disposed on a circuit board; and
a casing built with a base plate of package, having a fixing base glued thereon, the fixing base further comprising a battery seat for fitting batteries and a circuit board seat for laying the camera module, in which a fixing hole for setting a viewfinder is perforated in a position where the fixing base is glued to the base plate of package; and an opening is disposed in the base plate of package at a location corresponding to the lens and the viewfinder such that the lens and the viewfinder can be exposed to the air through the opening for picture-taking operation.

5. The easy digital camera according to claim 4, in which a buckling groove is formed in the circuit board seat for retaining the circuit board to lay the digital camera module.

6. The easy digital camera according to claim 4, in which the base plate of package is a polyvinyl chloride (PVC) lamina.
